(19) United States
(12) Patent Application Publication
(10) Pub. No.: US 2025/0222408 A1
(43) Pub. Date: Jul. 10, 2025

(54) METHOD FOR ONE-STEP REGULATION OF A PORE STRUCTURE AND SURFACE PROPERTIES OF A SILICON CARBIDE (SIC) MEMBRANE

(71) Applicant: NANJING TECH UNIVERSITY, Nanjing, Jiangsu Province (CN)

(72) Inventors: Weihong XING, Nanjing, Jiangsu Province (CN); Zhaoxiang ZHONG, Nanjing, Jiangsu Province (CN); Qian JIANG, Nanjing, Jiangsu Province (CN); Yaxin WANG, Nanjing, Jiangsu Province (CN); Yuling XIE, Nanjing, Jiangsu Province (CN); Nanping XU, Nanjing, Jiangsu Province (CN)

(73) Assignee: NANJING TECH UNIVERSITY, Nanjing, Jiangsu Province (CN)

(21) Appl. No.: 18/727,907

(22) PCT Filed: Feb. 10, 2023
(86) PCT No.: PCT/CN2023/075425

§ 371 Date: Mar. 17, 2025

(30) Foreign Application Priority Data
Jan. 11, 2022 (CN) 202210025969.9

(51) Int. Cl. B01D 67/00; B01D 71/02; C04B 35/573; C04B 35/626; C04B 38/00

(52) U.S. Cl. CPC B01D 67/00411; B01D 71/0215; C04B 35/573; C04B 35/6261; C04B 35/62635; C04B 38/0041; C04B 38/0054; C04B 38/0074; B01D 2323/081; B01D 2323/082; B01D 2323/10; B01D 2323/21813; B01D 2323/21817; B01D 2323/52; B01D 2325/0283; C04B 2235/3826; C04B 2235/5436; C04B 2235/6562; C04B 2235/6567; C04B 2235/94

(57) ABSTRACT

The present invention relates to a method for one-step regulation of a pore structure and surface properties of a silicon carbide (SiC) membrane. The method comprises: first, fully mixing SiC powder with a sintering aid, and then synergistically regulating a pore structure and surface wetting properties of a SiC membrane by controlling a molding pressure and a sintering condition. The amount of SiO₂ generated by oxidation of SiC is controlled, and in situ reaction of SiO₂ and the sintering aid is prompted to generate a neck connection, such that a sintering temperature of the SiC membrane can be reduced, and the strength and corrosion resistance properties of the SiC membrane can also be improved. The degree of sintering of the SiC membrane is effectively controlled by means of the regulation of the molding pressure and the sintering temperature. It is a simple method for one-step regulation of a pore structure and surface properties of a SiC membrane. The SiC membrane prepared has porosity adjustable in a range of 13% to 48% and a pore size adjustable in a range of 0.17 μm to 1 μm; and the SiC membrane has an initial dynamic water contact angle in a range of 12.01° to 66.8° and an underwater oil contact angle adjustable in a range of 120.3° to 155.1°. The SiC membrane prepared has high bending strength and pure water permeation properties and show a broad application prospect in the field of oil-water separation and emulsion preparation.

### TECHNICAL FIELD

The present invention pertains to the preparation of functional membrane materials among new materials, can be applied to the field of oil-water separation and emulsion preparation and particularly relates to a method for one-step regulation of a pore structure and surface properties of a silicon carbide (SiC) membrane.

### BACKGROUND ART

SiC membranes have advantages of high mechanical strength, a low thermal expansion coefficient and a high permeation flux and shows a broad application prospect in the field of oil-water separation and oil-water emulsion preparation. In order to reduce the production cost of SiC membranes, existing research focuses on an in-situ reaction sintering method. The variety of sintering aids has a great effect on sintering properties of SiC membranes. The pore structure and surface properties of the membranes have a significant effect on the separating property. Existing research mainly focuses on post-treatment of existing membrane materials, such as grafting modification, to improve the hydrophilic and hydrophobic properties of the membrane surface, and the preparation of ceramic membranes with different pore structures and surface properties by a multi-step method.

The porosity and pore size of a ceramic material depend on the formulation and molding method. Patent CN201410105442.2 discloses a method for regulating a pore structure of porous ceramic, wherein water or a solvent is used as a pore former and pores are formed in a ceramic green body by a freeze-drying method to achieve the regulation of the pore structure. However, addition of a pore former reduces the mechanical strength of the ceramic sample and the freeze-drying process limits industrialization. It is reported in literature [Eom et al, Journal of Asian Ceramic Societies, 2013, 1(3): 220-242] that adjusting the content of the pore former is the simplest way to adjust porosity, but excessive addition of the pore former will also cause an uneven distribution of aggregate particles, resulting in a wider distribution of membrane pore size, which is not conducive to the improvement of the separating property. Further, most of pore formers are not friendly to the environment in the removal process. Patent ZL201810995675.2 discloses a method for preparing a foam ceramic material through injection molding, heat preservation curing, sintering and other processes. Ceramic porosity (96% to 78%) and pore size (7 nm to 95 nm) are effectively regulated by regulating the content of the additive. However, the bending strength of the ceramic samples prepared by this method is less than 5 MPa, which is difficult to cope with the operating pressure in actual working conditions. Patent ZL201710316023.7 discloses a method for preparing a porous ceramic support based on molecular sieve membrane synthesis residue, which uses molecular sieve waste as a sintering aid to increase the strength of the material while reducing the sintering temperature. In order to change the properties of the membrane surface, the membrane surface needs to be modified. ZL201710001802.8 discloses a modification of a ceramic membrane by grafting a silane compound to the surface of the ceramic membrane and by heat treatment. This modification method requires secondary heat treatment to obtain a membrane with changed hydrophilicity and hydrophobicity. It is reported in literature [Zhu et al, Nature Publishing GroupAsian Materials, 2014, 6: e101] that most of modification work requires the second process of chemical reaction or physical deposition on the membrane surface to change the surface properties of the membrane. The pore structure and surface properties of the membrane have a significant effect on the efficiency of oil-water separation, emulsion preparation and other processes. The modification of the membrane surface increases preparation processes and preparation period. For this reason, the present invention proposes a method for controlling a pore structure and surface properties of a SiC membrane by synergistically regulating a molding pressure and a sintering temperature.

### SUMMARY OF THE INVENTION

The objective of the present invention is to regulating a pore size, porosity and surface properties of a SiC membrane at one step by only changing the preparation conditions of the SiC membrane. The present invention provides a simple method for effectively regulating a pore structure of a SiC membrane by only regulating a molding pressure and a sintering temperature without adding a pore former and without changing the formulation of mixed powder. The surface properties of the membrane are affected by the pore structure, so post-treatment for modification is not required, thereby reducing the preparation cost of the SiC membrane and obtaining a SiC membrane suitable for various application fields. The prepared SiC membrane can be applied to efficient separation of oil-containing wastewater and to rapid preparation of a water-in-oil emulsion.

In order to achieve the foregoing objective, the present invention adopts the following technical solution:

A method for regulating porosity and a pore size of a SiC ceramic membrane, comprising the following steps:
(1) weighing SiC aggregate with an average particle size of 5 μm and a sintering aid at a certain mass ratio and mixing them for a certain time in a ball mill or a three-dimensional mixer to ensure uniform mixing and obtain mixed powder A; screening the mixed powder A with a sieve to obtain mixed powder B with a uniform particle size; fully mixing the mixed powder B with a binder to obtain mixed powder C.
(2) making the mixed powder C into a green body of a certain shape under a certain molding pressure.
(3) putting the green body in a high temperature furnace, and carrying out in-situ sintering reaction according to a certain sintering procedure to obtain a SiC membrane with a different pore structure and surface properties.
(4) using the SiC membrane to treat oil-containing wastewater or prepare a water-in-oil emulsion and establish an application-oriented SiC membrane design and preparation method. wherein:

The sintering aid in step (1) is NaA molecular sieve waste powder (NaA(r)) recovered from a NaA molecular sieve membrane production line, industrial grade sodium silicate and zirconia; and the sintering aid accounts for 12% to 22% of the mass of the mixed powder A.

The speed of the ball mill or three-dimensional mixer used in step (1) for mixing powder is 100 rpm to 500 rpm, and the milling time is 2 h.

The mesh number of the wire sieve in step (1) is 50 mesh to 100 mesh.

The binder in step (1) is a polymer (polyvinyl alcohol) solution with a mass concentration of 2 wt. % to 15 wt. %;

The molding pressure in step (2) for regulating the green body is 8 MPa to 24 MPa.

The sintering procedure in step (3) is to: raise temperature from room temperature to 100° C. at a rate of 0.5° C./min to 2° C./min, then raise temperature to 600° C. to 1,400° C. at a rate of 2° C./min to 4° C./min, hold the temperature for 1 h to 4 h, and finally drop the furnace temperature naturally to room temperature.

The method for one-step regulation of a pore structure and surface properties of a silicon carbide (SiC) membrane in the present invention, wherein the SiC ceramic membrane is applied to the field of oil-water separation and has a good oil-water separation capacity and an oil retention rate of more than 90% under the conditions of an operating pressure of less than 0.1 MPa and a membrane surface flow rate of less than 1 m/s. At the same time, when applied to a preparation process of a water-in-oil emulsion, under the condition of a high membrane emulsion water flux, a uniform emulsion with a micron-scale particle size can be prepared.

### Advantages of the Present Invention

1. A sintering aid reacts in situ at a high temperature with SiO₂ generated by oxidation of the surface of SiC particles to form a tight neck connection among the SiC particles, which effectively reduces the sintering temperature and preparation cost of the SiC membrane.
2. Without changing the formulation, the pore size, porosity and surface properties of the SiC membrane are effectively regulated by changing molding pressure and sintering temperature, which is simple, quick and effective.
3. The SiC membrane prepared has high bending strength and pure water permeation properties. The application field of the membrane can be extended by regulating its surface properties.
4. The SiC membrane prepared can effectively intercept oil droplets in oil-containing wastewater, and has a broad application prospect in the field of wastewater treatment.
5. The SiC membrane prepared can realize the rapid preparation of a water-in-oil emulsion and has a broad application prospect in the fields of emulsified diesel oil and emulsified heavy oil.

### BRIEF DESCRIPTION OF THE DRAWINGS

FIG. 1 is an SEM image of a SiC membrane prepared in Embodiment 1.

FIG. 2 shows a pore size distribution of a SiC membrane prepared in Embodiments 1 and 7.

FIG. 3 shows shapes of an oil droplet on a surface of a SiC membrane prepared in Embodiments 3, 4 and 7 in different stages of an adhesion test.

FIG. 4 shows strength and corrosion resistance of different sintering aids.

FIG. 5 shows a metallographic microscope image and droplet particle size distribution of the emulsion prepared.

### DETAILED DESCRIPTION

Below the present invention is further described in detail in conjunction with embodiments. The following embodiments are intended to describe and not to limit the present invention.

### Embodiment 1

A method for regulation of a pore structure and surface properties of a SiC membrane in this embodiment, comprising the following steps:

Weighing 88% SiC particles with an average particle size of 5 μm and 12% NaA(r) with an average particle size of 2 μm by mass ratio, putting them in a ball mill tank after preliminary mixing, and milling at 200 rpm for 2 h to obtain mixed powder A; screening the milled mixed powder A on a 60-mesh wire sieve to obtain uniform mixed powder B; fully mixing a PVA solution with a mass concentration of 8% with the mixed powder B at a mass ratio of 0.05:1 in a mortar to obtain mixed powder C, and then pressing the mixed powder C into a green body sheet under a molding pressure of 8 MPa by a dry pressing method; putting the green body into a precision high-temperature furnace, raising temperature from room temperature to 100° C. at a rate of 1° C./min, then raising temperature to 1,000° C. at a rate of 2° C./min, holding the temperature for 2 h, and finally reducing the furnace temperature naturally to room temperature to obtain a SiC membrane.

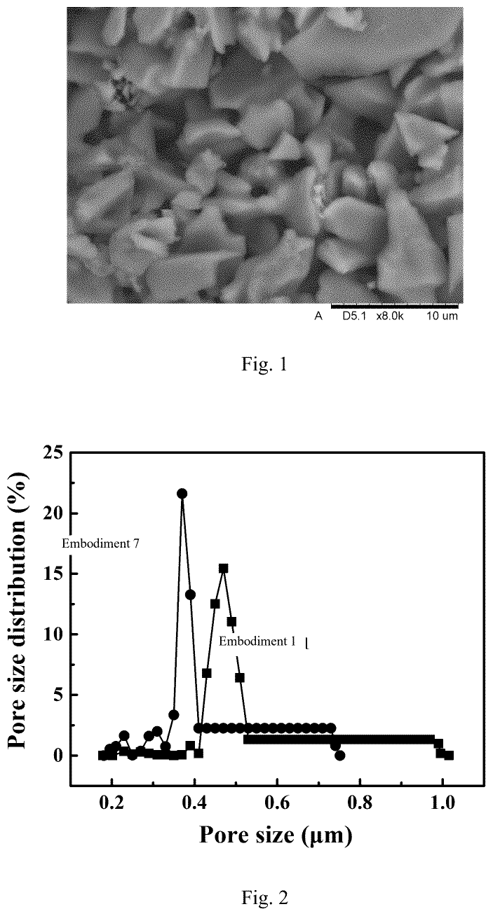

FIG. 1 is an SEM image of a SiC membrane prepared in Embodiment 1. It can be seen from the figure that many neck connections are formed among particles at a sintering temperature of 1,000° C. The prepared SiC membrane has porosity of 48%, an average pore size of 0.53 μm, with a pore size distribution shown in FIG. 2, bending strength of 45 MPa, pure water permeation properties up to 4,000 Lm⁻²h⁻¹bar⁻¹, an initial dynamic water contact angle of 12.7°, an underwater oil contact angle of 150.1° and an underwater oil adhesive force of 0.057 mN. Under a transmembrane pressure of 0.5 bar, the oil retention rate to 500 ppm oil-containing wastewater is up to 95% and the steady flux exceeds 160 Lm⁻²h⁻¹.

### Embodiment 2

Weighing 78% SiC (with an average particle size of 5 μm), 12% industrial grade sodium silicate and 10% zirconia (with an average particle size of 1 μm) by mass ratio, putting them in a ball mill tank after preliminary mixing, and milling at 350 rpm for 2 h to obtain mixed powder A; screening the milled mixed powder A on a 100-mesh wire sieve to obtain uniform mixed powder B; fully mixing a PVA solution with a mass concentration of 15% with the mixed powder B at a mass ratio of 0.03:1 in a mortar to obtain mixed powder C, and then pressing the mixed powder C into a green body sheet under a molding pressure of 8 MPa by a dry pressing method; putting the green body into a precision high-temperature furnace, raising temperature from room temperature to 100° C. at a rate of 0.5° C./min, then raising temperature to 600° C. at a rate of 2° C./min, holding the temperature for 2 h, and finally reducing the furnace temperature naturally to room temperature to obtain a porous SiC ceramic membrane.

The prepared SiC membrane has porosity of 44%, an average pore size of 0.56 μm, bending strength of 71 MPa, pure water permeation properties of 4,580 Lm⁻²h⁻¹bar⁻¹, an initial dynamic water contact angle of 33.1°, an underwater oil contact angle of 153.1° and an underwater oil adhesive force of 0.037 mN.

### Embodiment 3

Weighing 78% SiC (with an average particle size of 5 μm), 12% industrial grade sodium silicate and 10% zirconia (with an average particle size of 1 μm) by mass ratio, putting them in a ball mill tank after preliminary mixing, and milling at 250 rpm for 2 h to obtain mixed powder A; screening the milled mixed powder A on a 60-mesh wire sieve to obtain uniform mixed powder B; fully mixing a PVA solution with a mass concentration of 10% with the mixed powder B at a mass ratio of 0.01:1 in a mortar to obtain mixed powder C, and then pressing the mixed powder C into a green body sheet under a molding pressure of 16 MPa by a dry pressing method; putting the green body into a precision high-temperature furnace, raising temperature from room temperature to 100° C. at a rate of 2° C./min, then raising temperature to 1,000° C. at a rate of 4° C./min, holding the temperature for 4 h, and finally reducing the furnace temperature naturally to room temperature to obtain a porous SiC ceramic membrane.

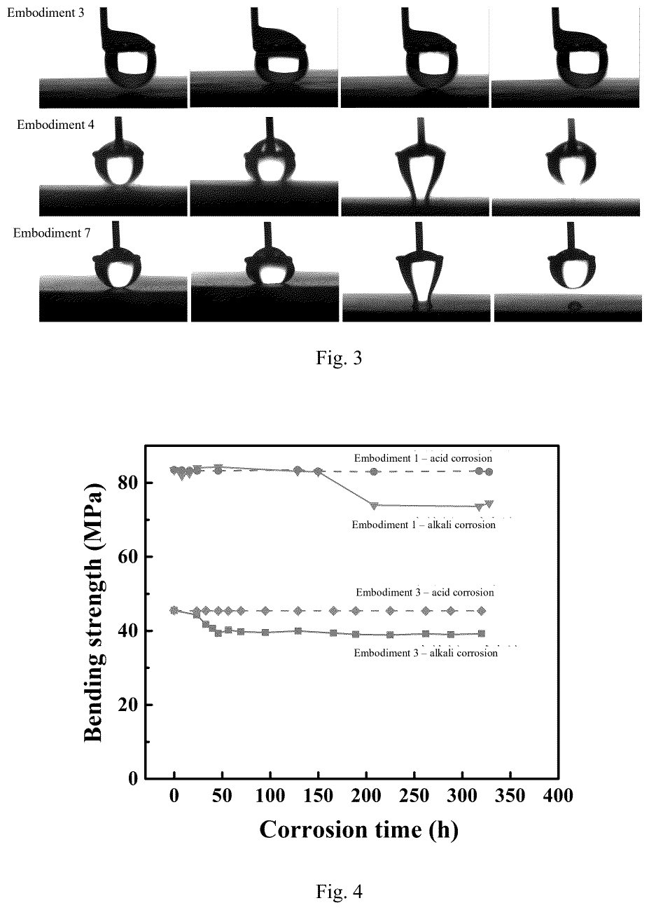

The prepared SiC membrane has porosity of 36%, an average pore size of 1 μm, bending strength of 85 MPa, pure water permeation properties of 5,200 Lm⁻²h⁻¹bar⁻¹, an initial dynamic water contact angle of only 12.6°, an underwater oil contact angle of 155.1° and an underwater oil adhesive force as low as 0.041 mN. In the process of the adhesion test (FIG. 3), the adhesive force of the membrane surface had no obvious effect on the shape of oil droplets leaving the membrane surface. FIG. 4 shows the strength variations of different formulations of SiC membrane (Embodiment 1 and Embodiment 3) sintered at 1,000° C. after long-term hot acid-alkali corrosion. As shown in FIG. 4, when soaked in a 1% NaOH solution and a 20% H₂SO₄ solution at 80° C., the SiC membrane did not have significant change in strength, showing good chemical corrosion resistance.

### Embodiment 4

Weighing 88% SiC (with an average particle size of 5 μm) and 12% NaA(r) (with an average particle size of 2 μm) by mass ratio, putting them in a ball mill tank after preliminary mixing, and milling at 500 rpm for 2 h to obtain mixed powder A; screening the milled mixed powder A on a 100-mesh wire sieve to obtain uniform mixed powder B; fully mixing a PVA solution with a mass concentration of 10% with the mixed powder B at a mass ratio of 0.05:1 in a mortar to obtain mixed powder C, and pressing the mixed powder C into a green body sheet under a molding pressure of 8 MPa by a dry pressing method; putting the green body into a precision high-temperature furnace, raising temperature from room temperature to 100° C. at a rate of 2° C./min, then raising temperature to 1,200° C. at a rate of 2° C./min, holding the temperature for 3 h, and finally reducing the furnace temperature naturally to room temperature to obtain a porous SiC ceramic membrane.

The prepared SiC membrane has porosity of 40%, an average pore size of 0.67 μm, bending strength of 81 MPa, pure water permeation properties of 3,800 Lm⁻²h⁻¹bar⁻¹, an initial dynamic water contact angle of 12.01°, an underwater oil contact angle of 150.2° and an underwater oil adhesive force of 0.056 mN. In the process of the adhesion test (FIG. 3), the adhesive force of the membrane surface caused a slight change in the shape of oil droplets leaving the membrane surface, but the oil droplets could be completely stripped from the membrane surface.

### Embodiment 5

Weighing 88% SiC (with an average particle size of 5 μm) and 12% NaA(r) (with an average particle size of 2 μm) by mass ratio, putting them in a ball mill tank after preliminary mixing, and milling at 100 rpm for 2 h to obtain mixed powder A; screening the milled mixed powder A on a 60-mesh wire sieve to obtain uniform mixed powder B; fully mixing a PVA solution with a mass concentration of 2% with the mixed powder B at a mass ratio of 0.05:1 in a mortar to obtain mixed powder C, and pressing the mixed powder C into a green body sheet under a molding pressure of 20 MPa by a dry pressing method; putting the green body into a precision high-temperature furnace, raising temperature from room temperature to 100° C. at a rate of 1° C./min, then raising temperature to 1,300° C. at a rate of 2° C./min, holding the temperature for 2 h, and finally reducing the furnace temperature naturally to room temperature to obtain a porous SiC ceramic membrane.

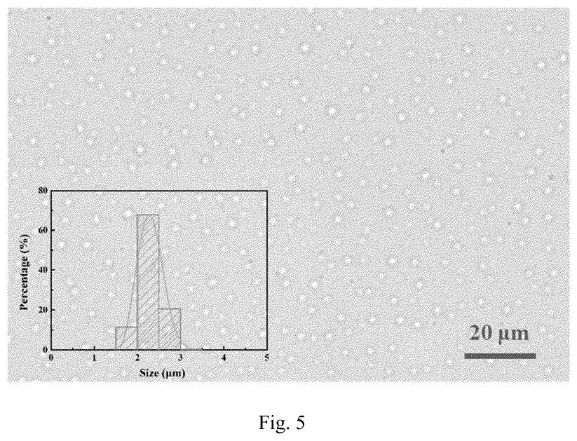

The prepared SiC membrane has porosity of 26%, an average pore size of 0.58 μm, bending strength of 76 MPa, pure water permeation properties of 2,300 Lm⁻²h⁻¹bar⁻¹, an initial dynamic water contact angle of 50.21°, an underwater oil contact angle of 146.1° and an underwater oil adhesive force of 0.118 mN. The SiC membrane was used as an emulsifying medium to control the flow rate of the membrane surface at 0.68 m/s and control the water phase to permeate the membrane and enter the oil phase at a flow rate of 10 mL/min. The prepared lubricant emulsion has a water content of 10% and an emulsion flux of 1,910 Lm⁻²h⁻¹. FIG. 5 shows a metallographic microscope image and particle size distribution of a water-in-oil emulsion. The particle size of the emulsion droplets is about 2 μm, in a monodisperse state, with a concentrated distribution and a dispersion of only 0.405.

### Embodiment 6

Weighing 88% SiC (with an average particle size of 5 μm) and 12% NaA(r) (with an average particle size of 2 μm) by mass ratio, putting them in a ball mill tank after preliminary mixing, and milling at 400 rpm for 2 h to obtain mixed powder A; screening the milled mixed powder A on a 60-mesh wire sieve to obtain uniform mixed powder B; fully mixing a PVA solution with a mass concentration of 10% with the mixed powder B at a mass ratio of 0.04:1 in a mortar to obtain mixed powder C, and pressing the mixed powder C into a green body sheet under a molding pressure of 24 MPa by a dry pressing method; putting the green body into a precision high-temperature furnace, raising temperature from room temperature to 100° C. at a rate of 1° C./min, then raising temperature to 1,400° C. at a rate of 3° C./min, holding the temperature for 1 h, and finally reducing the furnace temperature naturally to room temperature to obtain a porous SiC ceramic membrane.

The prepared SiC membrane has porosity of 13%, an average pore size of 0.175 μm and bending strength of 21 MPa. Due to a low pore size and porosity of the membrane material, pure water permeation properties are 150 Lm⁻²h⁻¹bar⁻¹, and the retention rate to oil in oil-containing wastewater is up to 99%. The initial dynamic water contact angle is 66.8°, the underwater oil contact angle is 120.3° and the underwater oil adhesive force is 0.080 mN.

### Embodiment 7

Weighing 88% SiC (with an average particle size of 5 μm) and 12% NaA(r) (with an average particle size of 2 μm) by mass ratio, putting them in a ball mill tank after preliminary mixing, and milling at 350 rpm for 2 h to obtain mixed powder A; screening the milled mixed powder A on a 60-mesh wire sieve to obtain uniform mixed powder B; fully mixing a PVA solution with a mass concentration of 8% with the mixed powder B at a mass ratio of 0.05:1 in a mortar to obtain mixed powder C, and pressing the mixed powder C into a green body sheet under a molding pressure of 24 MPa by a dry pressing method; putting the green body into a precision high-temperature furnace, raising temperature from room temperature to 100° C. at a rate of 1° C./min, then raising temperature to 1,000° C. at a rate of 4° C./min, holding the temperature for 2 h, and finally reducing the furnace temperature naturally to room temperature to obtain a porous SiC ceramic membrane.

FIG. 2 shows a pore size distribution of a SiC membrane prepared in Embodiments 1 and 7. It can be seen from the figure that with the increase of the molding pressure, the pore size of the SiC membrane is effectively normalized and the most probable pore size is reduced. The prepared SiC membrane has porosity of 40%, an average pore size of 0.48 μm, bending strength of 48 MPa, pure water permeation properties of 1,700 Lm⁻²h⁻¹bar⁻¹, an initial dynamic water contact angle of 15.45°, an underwater oil contact angle of 150.3° and an underwater oil adhesive force of 0.132 mN. The adhesive force of the membrane surface is high, causing the oil droplets leaving the membrane surface to deform (FIG. 3). The oil droplets cannot be completely stripped from the membrane surface, and part of the oil phase remains on the membrane surface.

### Comparison Example 1

It is reported in literature (Eometal, Clays and Clay Minerals, 2015, 63(3): 222-234) that under a transmembrane pressure of more than 3 bar, the oil retention rate to 600 ppm oil-containing wastewater is only 84.1% and the steady flux is 90 Lm⁻²h⁻¹.

### Comparison Example 2

It is reported in literature (Zhu etal, Journal of Membrane Science, 2014, 466: 36-44) that under a transmembrane pressure of 3.4 bar, the oil retention rate to 500 ppm oil-containing wastewater is 98% and the steady flux is as low as 13.55 Lm⁻²h⁻¹.

The comparison of Embodiment 1 with comparison example 1 and comparison example 2 in filtering data is shown in Table 2.

### Comparison Example 3

It is reported in literature (Jing etal, Desalination, 2006, 191: 219-222) that a water-in-oil emulsion was prepared using a hydrophilic ceramic membrane by membrane emulsification. The comparison between Embodiment 5 and comparison example 3 in membrane emulsification data is shown in Table 3.

TABLE 1
Comparison of Sample Characterization Results in Embodiments 1, 4, 5, 6, 7

| | Sample | | | | | |
|---|---|---|---|---|---|---|
| | preparation | Sintering | Average | | Initial water | Underwater |
| | pressure | temperature | pore size | Porosity | contact angle | oil adhesive |
| Sample | (MPa) | (° C.) | (μm) | (%) | (°) | force (mN) |
| Embodiment | 8 | 1000 | 0.53 | 48 | 12.7 | 0.057 |
| 1 | | | | | | |
| Embodiment | 8 | 1200 | 0.67 | 40 | 12.01 | 0.056 |
| 4 | | | | | | |
| Embodiment | 20 | 1300 | 0.58 | 26 | 50.21 | 0.118 |
| 5 | | | | | | |
| Embodiment | 24 | 1400 | 0.175 | 13 | 66.8 | 0.08 |
| 6 | | | | | | |
| Embodiment | 24 | 1000 | 0.48 | 40 | 15.45 | 0.132 |
| 7 | | | | | | |

The results in Table 1 show that under the same formulation, the changes in sample preparation pressure and sintering temperature enable one-step regulation of a pore structure and surface properties of a SiC membrane.

TABLE 2
Comparison between Embodiment 1 and Comparison
Examples 1 & 2 in Filtering Data

| | Oil-containing | Transmembrane | | |
|---|---|---|---|---|
| | wastewater | pressure | Reten- | Steady |
| | concentration | difference | tion | flux |
| Sample | (ppm) | (bar) | rate (%) | (Lm⁻²h⁻¹) |
| Embodiment 1 | 500 | 0.5 | 95 | 162 |
| Comparison | 600 | 3.03 | 84.1 | 90 |
| example 1 | | | | |
| Comparison | 500 | 3.4 | 98 | 13.55 |
| example 2 | | | | |

The results in Table 2 show that when oil-containing wastewater with a similar oil concentration is treated, the SiC membrane of Embodiment 1 has a high oil retention rate under a low transmembrane pressure difference and meanwhile, its steady flux is much higher than the oil-water separating property in comparison example 1 and comparison example 2, proving an advantage of the prepared membrane in the applications of oil-water separation.

TABLE 3
Comparison between Embodiment 5 and Comparison
Example 3 in Membrane Emulsification Data

| | Membrane pore | Emulsion particle | Emulsification |
|---|---|---|---|
| Sample | size (μm) | size (μm) | flux (Lm⁻²h⁻¹) |
| Embodiment 5 | 0.58 | 2 | 1910 |
| Comparison | 0.16 | 1-2 | 140.6 |
| example 3 | | | |

As shown in Table 3, compared with the comparison examples, the SiC membrane prepared in Embodiment 5 can prepare a homogeneous oil-in-water emulsion with an equivalent particle size and increases the emulsion flux by more than 10 times, facilitating its application in the preparation of a water-in-oil emulsion.

1. A method for one-step regulation of a pore structure and surface properties of a silicon carbide (SiC) membrane, wherein the method comprises the following steps:
(1) weighing SiC aggregate with an average particle size of 5 μm and a sintering aid at a certain mass ratio and mixing them for a certain time in a ball mill or a three-dimensional mixer to ensure uniform mixing and obtain mixed powder A; screening the mixed powder A with a sieve to obtain mixed powder B with a uniform particle size; fully mixing the mixed powder B with a binder to obtain mixed powder C;
(2) making the mixed powder C into a green body of a certain shape under a certain molding pressure; and
(3) putting the green body in a high temperature furnace, and carrying out in-situ sintering reaction according to a certain sintering procedure to obtain a SiC membrane with a different pore structure and surface properties.

2. The method for one-step regulation of a pore structure and surface properties of a SiC membrane according to claim 1, wherein the sintering aid in step (1) is NaA molecular sieve membrane synthesis waste, industrial grade sodium silicate and zirconia; the sintering aid accounting for 12% to 22% of the mass of the mixed powder A; the speed of the ball mill or three-dimensional mixer used for mixing powder being 100 rpm to 500 rpm, and the milling time being 2 h.

3. The method for one-step regulation of a pore structure and surface properties of a SiC membrane according to claim 1, wherein the mesh number of the sieve in step (1) is 50 mesh to 100 mesh.

4. The method for one-step regulation of a pore structure and surface properties of a SiC membrane according to claim 1, wherein the binder in step (1) is a polyvinyl alcohol solution with a mass concentration of 2 wt. % to 15 wt. %.

5. The method for one-step regulation of a pore structure and surface properties of a SiC membrane according to claim 1, wherein the molding pressure in step (2) for regulating the green body is 8 MPa to 24 MPa, and the shape being sheet, tube, multi-channel, slab, etc.

6. The method for one-step regulation of a pore structure and surface properties of a SiC membrane according to claim 1, wherein the sintering procedure in step (3) is to: raise temperature from room temperature to 100° C. at a rate of 0.5° C./min to 2° C./min, then raise temperature to 600° C. to 1,400° C. at a rate of 2° C./min to 4° C./min, hold the temperature for 1 h to 4 h, and reduce the temperature naturally to room temperature.

7. The method for one-step regulation of a pore structure and surface properties of a SiC membrane according to any of claim 1 to claim 6, wherein the SiC ceramic membrane is applied to oil-water separation and the preparation process of a water-in-oil emulsion.
